(19) United States
(12) Patent Application Publication
(10) Pub. No.: US 2010/0012375 A1
(43) Pub. Date: Jan. 21, 2010

(54) ELECTRICAL BUSWAY AND OFFSET COUPLING ASSEMBLY THEREFOR

(76) Inventors: ARTHUR J. JUR, Greenwood, SC (US); Phillip D. Miller, Greenwood, SC (US); Douglas V. Taylor, Greenwood, SC (US)

Correspondence Address: Martin J. Moran, 1000 Cherrington Parkway, Moon Township, PA, 15108, US

(21) Appl. No.: 12/175,507

(22) Filed: Jul. 18, 2008

(51) Int. Cl. H02G 3/06; H01R 4/60

(52) U.S. Cl. 174/88 B; 439/210

(57) ABSTRACT

A coupling assembly is provided for an electrical busway having a first section and a second section. The coupling assembly includes a plurality of electrical conductors that electrically connect the first and second sections of the electrical busway. A plurality of electrical insulators are positioned to electrically insulate the plurality of electrical conductors. The coupling assembly is structured to offset the first section of electrical busway a predetermined, non-zero distance from the second section of electrical busway.

### BACKGROUND OF THE INVENTION

1. Field of the Invention

The invention relates generally to electrical conductors and, more particularly, to electrical busways. The invention also relates to coupling assemblies for electrical busways.

2. Background Information

Various electrical components are defined by, and subject to, regulatory requirements. For example and without limitation, the Underwriter's Laboratory (UL) defines an “electrical busway”, at UL 857, as a grounded metal enclosure containing factory mounted conductors that are usually copper or aluminum bars, rods, or tubes. Similarly, the National Electric Code (NEC) defines an electrical busway as a grounded metal enclosure containing factory mounted, bare, or insulated conductors, which are usually copper or aluminum bars, rods, or tubes.

Typically, electrical busways are comprised of a number of straight sections joined by bridge joints. Each of the busway sections includes a plurality of electrical conductors (e.g., wires, cables or other suitable conductive members made from an electrically conductive material such as, for example and without limitation, copper or aluminum) that are insulated by a coating, film or sleeve of a non-conductive material (e.g., electrical insulator) and enclosed in a housing, such as an elongated rail structure. The electrical conductors of the electrical busway receive, for example, different phases of alternating current power and provide power to electrical equipment that is electrically connected to the electrical busway.

Bridge joints are sized to carry current from one electrical busway section to another adjacent electrical busway section. Known bridge joints are sized with only the necessary length to make a straight connection from one electrical busway section to the next. Such joints typically also need to carry the weight of a full section of electrical busway as the busway is often held in the air with only one hanger per section. The bridge joints electrically interconnect the electrical conductors of one electrical busway section with the corresponding electrical conductors of another, different electrical busway section.

Different sections of the electrical busway must be suitably electrically connected to bridge a conductive path between the sections. During installation of a busway run, unplanned obstructions are sometimes installed during construction. In order to accommodate such obstructions, offsets are often needed in the busway. Typically, such offsets have been fabricated by the welding of busbars and enclosure housings in order to form 90 degree angles. Such offsets require special ordering, are labor and cost-intensive, and often cause delays in the construction process.

There is, therefore, room for improvement in electrical busways and in coupling assemblies therefor.

### SUMMARY OF THE INVENTION

These needs and others are met by embodiments of the invention, which are directed to a coupling assembly for electrically connecting sections of an electrical busway together at an offset from each other.

As one aspect of the invention, a coupling assembly is provided for an electrical busway. The electrical busway includes a first section having a first longitudinal axis and a second section having a second longitudinal axis. The coupling assembly comprises: a plurality of electrical conductors, the plurality of electrical conductors having a first portion and an opposite second portion, the first portion being structured to removably electrically and mechanically couple to the first section of electrical busway, and the second portion structured to removably electrically and mechanically couple to the second section of electrical busway, the electrical conductors having a third longitudinal axis extending between the first portion and the opposite second portion; and a plurality of electrical insulators positioned to electrically insulate the plurality of electrical conductors. The coupling assembly being structured to offset the first longitudinal axis a predetermined non-zero distance from the second longitudinal axis.

The first section of electrical busway may include a plurality of first bus members and the second section of electrical busway may include a plurality of second bus members. Each of the plurality of electrical conductors may be structured to electrically connect a corresponding one of the first bus members of the first section to a corresponding one of the second bus members of the second section.

Each of the plurality of electrical conductors may comprise a first plate having a first surface and an opposite second surface and a second plate having a first surface and an opposite second surface. The opposite second surface of the first plate and the first surface of the second plate may be structured to electrically and mechanically engage a corresponding one of the first bus members of the first section and a corresponding one of the second bus members of the second section.

The plurality of electrical conductors and the plurality of electrical insulators may be arranged in an alternating stack coupled together by a fastening mechanism. The alternating stack may comprise an arrangement of the plurality of electrical conductors and the plurality of electrical insulators wherein each of the plurality of electrical conductors lies between a corresponding pair of the plurality of electrical insulators. The fastening mechanism may comprise a fastening member passing through the alternating stack. The fastening mechanism may comprise a first fastening member passing through the alternating stack proximate the first portion and a second fastening member passing through the alternating stack proximate the second portion.

The third longitudinal axis may be normal to both of the first longitudinal axis and the second longitudinal axis. The electrical conductors may have a generally rectangular cross section.

As another aspect of the invention, an electrical busway is provided. The electrical busway comprises: a first section having a first longitudinal axis; a second section spaced apart from the first section, the second section having a second longitudinal axis; and a coupling assembly comprising: a plurality of electrical conductors, the plurality of electrical conductors having a first portion and an opposite second portion, the first portion removably electrically and mechanically coupled to the first section of electrical busway, and the second portion removably electrically and mechanically coupled to the second section of electrical busway, the electrical conductors having a third longitudinal axis extending between the first portion and the opposite second portion; and a plurality of electrical insulators positioned to electrically insulate the plurality of electrical conductors. The coupling assembly being structured to offset the first longitudinal axis a predetermined non-zero distance from the second longitudinal axis.

As a further aspect of the invention, a coupling assembly for an electrical busway is provided. The electrical busway includes a first section comprising a first housing having a first longitudinal axis and a second section comprising a second housing having a second longitudinal axis. The coupling assembly comprises: a plurality of electrical conductors, the plurality of electrical conductors having a first portion and an opposite second portion, the first portion being structured to removably electrically and mechanically couple to the first section of electrical busway, and the second portion structured to removably electrically and mechanically couple to the second section of electrical busway, the electrical conductors having a third longitudinal axis extending between the first portion and the second portion; a plurality of electrical insulators positioned to electrically insulate the plurality of electrical conductors; and a coupler housing having a first portion structured to be coupled to the first housing and a second portion structured to be coupled to the second housing. The coupling assembly being structured to offset the first longitudinal axis a predetermined non-zero distance from the second longitudinal axis.

### BRIEF DESCRIPTION OF THE DRAWINGS

A full understanding of the invention can be gained from the following description of the preferred embodiments when read in conjunction with the accompanying drawings in which:

FIG. 1 is an isometric view of a coupling assembly in a portion of an electrical busway in accordance with an embodiment of the invention;

FIG. 2 is a partially exploded isometric view of the coupling assembly and portion of the electrical busway of FIG. 1;

FIG. 3 is an elevation view of the coupling assembly of FIG. 1;

FIG. 4 is a side elevation view of the coupling assembly and portion of the electrical busway of FIG. 1;

FIG. 5 is an isometric view of the coupling assembly of FIG. 1 including a housing; and

FIG. 6 is an isometric view of a coupling assembly in a portion of an electrical busway in accordance with another embodiment of the invention.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the term “electrical busway” refers to an assembly of electrical conductors housed within a supporting structure such as, for example and without limitation, a rail structure. The electrical conductors receive electrical power from, for example, a utility or other suitable power source.

As employed herein, the term “electrical conductor” means any known or suitable component expressly intended to conduct electrical current. An electrical conductor may be relatively flexible, and expressly includes, but is not limited to, electrical wires and electrical cables.

As employed herein, the term “bus bar” refers to a substantially rigid (e.g., inflexible) electrical conductor.

As employed herein, the term “electrical terminal” refers to a portion of an electrical busway to which a corresponding electrical conductor is electrically connected.

As employed herein, the statement that two or more parts are “coupled” together shall mean that the parts are joined together either directly or joined through one or more intermediate parts.

As employed herein, the term “number” refers to the quantity one or an integer greater than one (i.e., a plurality).

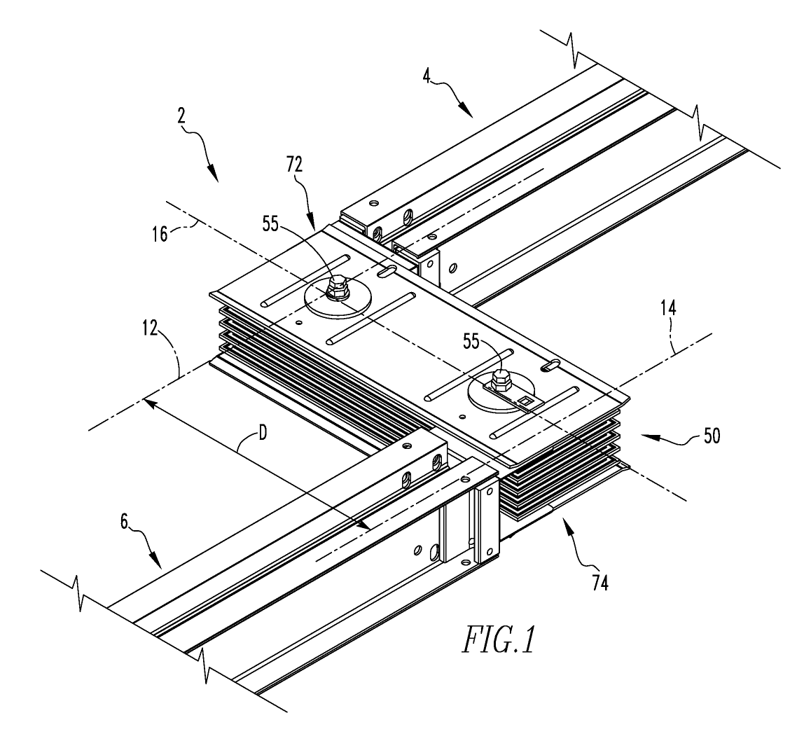

FIGS. 1-5 show one example of a coupling assembly 50 for an electrical busway 2, in accordance with one non-limiting embodiment of the invention. The electrical busway 2 includes first and second sections 4,6. First section 4 has a first central axis 12 extending longitudinally. Likewise, second section 6 has a second central axis 14 extending longitudinally. The first and second sections 4,6 are spaced apart from, and offset a distance with respect to, each other. Specifically, the first central axis 12 and the second central axis 14 are offset a distance D, as shown in FIG. 1. It will be appreciated that the offset distance D may be any suitable, non-zero distance as desired for the particular application. Thus, it will be appreciated that the disclosed coupling assembly 50 is structured to provide an electrical busway offset joint providing an offset to two adjacent busway sections 4,6.

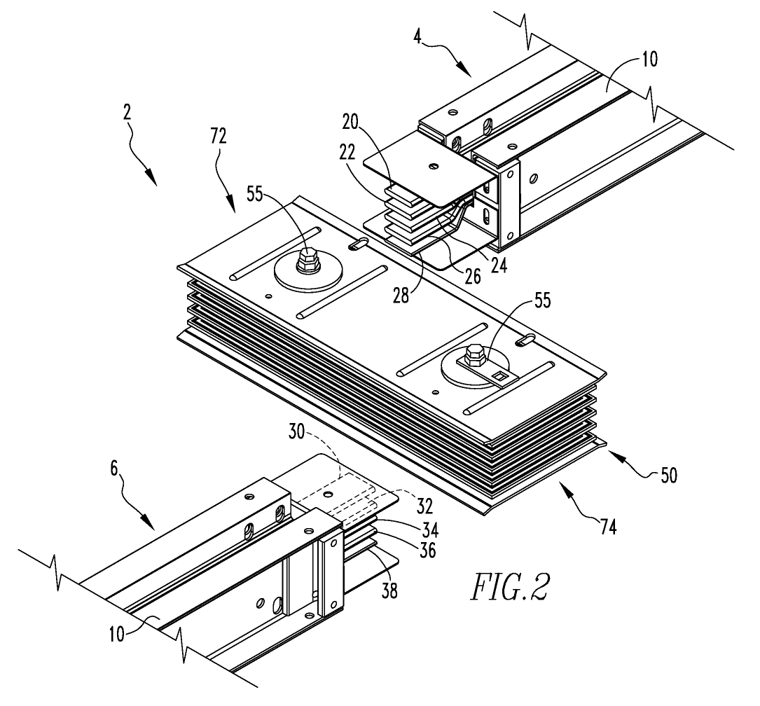

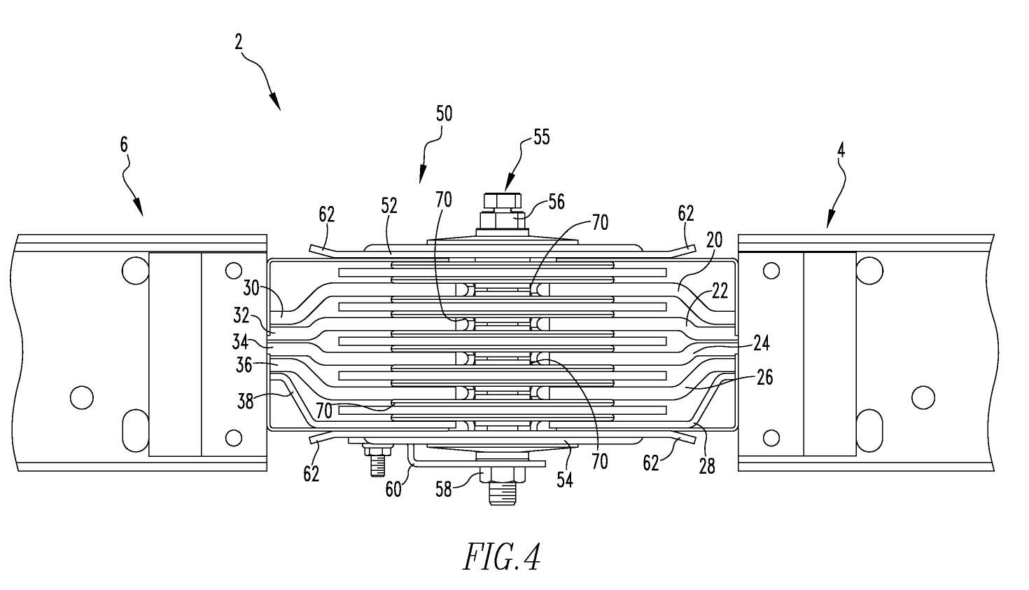

As shown in FIGS. 2 and 4, the first section 4 of busway 2 includes at least one, and typically four, elongated bus members and a ground member (not shown) that end at terminals 20,22,24,26,28. Likewise, the second section 6 of busway 2 includes a corresponding number of elongated bus members and a ground member (not shown) that end at terminals 30,32,34,36,38. Typically, three of the elongated bus members are “live” conductors coupled to a power source. The fourth bus member is typically a neutral bus member. The bus members are sandwiched in a non-conductive housing 10. The first and second sections 4,6 typically have a generally quadrilateral cross-section shape. It will, however, be appreciated that any known or suitable alternative number, type and/or configuration of electrical conductors could be employed, without departing from the scope of the invention

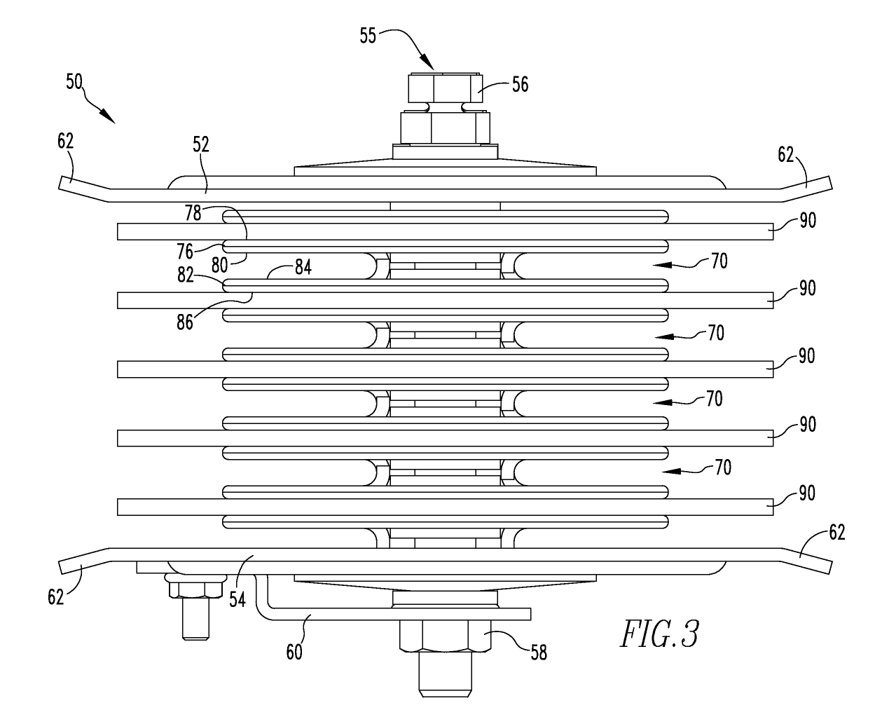

The coupling assembly 50 is provided to facilitate the connection between offset first and second sections 4,6 of electrical busway 2. Referring to FIGS. 3 and 4, the coupling assembly 50 includes a first cover plate 52 and a second cover plate 54. Depending on the application (i.e., the desired offset distance D) one or more fastening members 55 provide compressive force on the cover plates 52,54. In the examples shown in FIGS. 1-4, each of fastening members 55 include two-headed bolts 56 that extend through and connect the two cover plates 52,54 with a hex nut 58 at the opposite end that is retained by a nut retaining bracket 60. Preferably, each cover plate 52,54 includes an inclined periphery 62 to provide lead in for adjoining busway sections 4,6. It will be appreciated that other suitable fastening mechanisms may be employed in place of, or in addition to, two-headed bolts 56 and the related fastening components as were discussed above.

Coupling assembly 50 further includes a plurality of electrical conductors 70 generally separated by a plurality of electrical insulators 90 arranged in an alternating stack between the first and second cover plates 52,54. Preferably each of the electrical conductors 70 and electrical insulators 90 are of generally rectangular planar shape and include a corresponding passage(s) through which the one or more two headed bolts 56 may extend. Referring to FIG. 3, generally, the plurality of electrical conductors 70 includes a first portion 72 and an opposite second portion 74, with the first portion 72 being structured to removably electrically and mechanically couple the first section 4 of electrical busway 2, and the opposite second portion 74 being structured to removably electrically and mechanically couple the second section 6 of electrical busway 2. Each of the plurality of electrical conductors 70 have a third central axis 16 extending longitudinally (one is shown in FIG. 1). Preferably, the coupling assembly 50 is oriented such that the third central axis 16 is normal to both the first axis 12 and second axis 14.

More specifically, as best shown in FIG. 3, each of the electrical conductors 70 includes a first plate member 76 having a first surface 78 and an opposite second surface 80 and a second plate member 82 having a first surface 84 and an opposite second surface 86. The opposite second surface 80 of the first plate member 76 and the first surface 84 of the second plate member 82 are structured to electrically and mechanically engage a corresponding one of the terminals 20,22,24,26,28 of the first section 4 and a corresponding one of the terminals 30,32,34,36,38 of the second section 6, thus providing an electrical connection between corresponding pairs of terminals 20,22,24,26,28 and 30,32,34,36,38, respectively. In other words, each of the plurality of electrical conductors 70 provides an electrical pathway connecting a bus member of the first section 4 to a corresponding bus member of the second section 6.

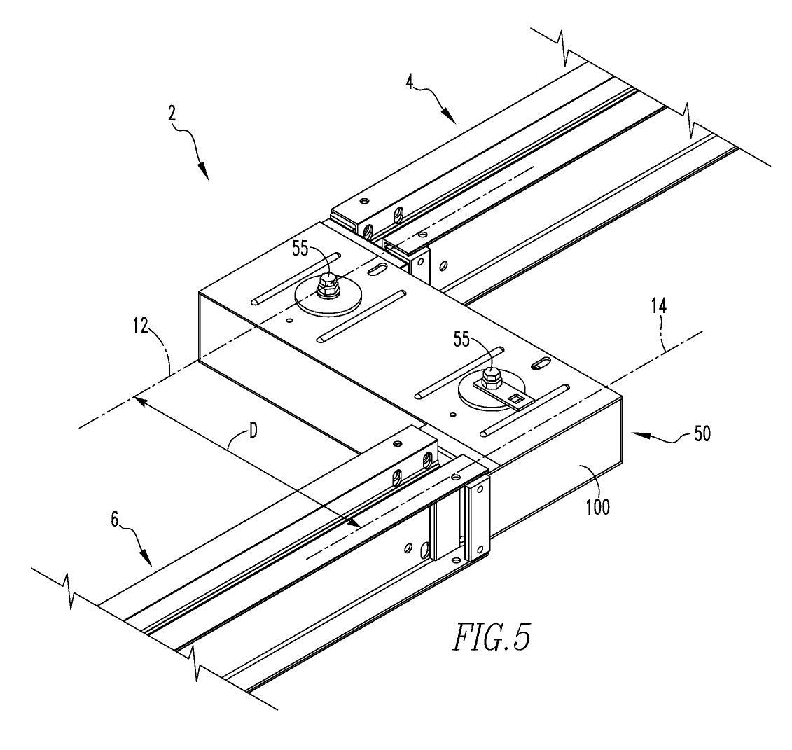

FIG. 5 shows a completed section of electrical busway wherein a non-conductive housing 100 surrounds and encases the plurality of electrical conductors 70 and electrical insulators 90 of FIG. 3. Thus, the housing 100 serves to surround, protect and/or electrically insulate the joint between sections 4,6, respectively, of the electrical busway 2.

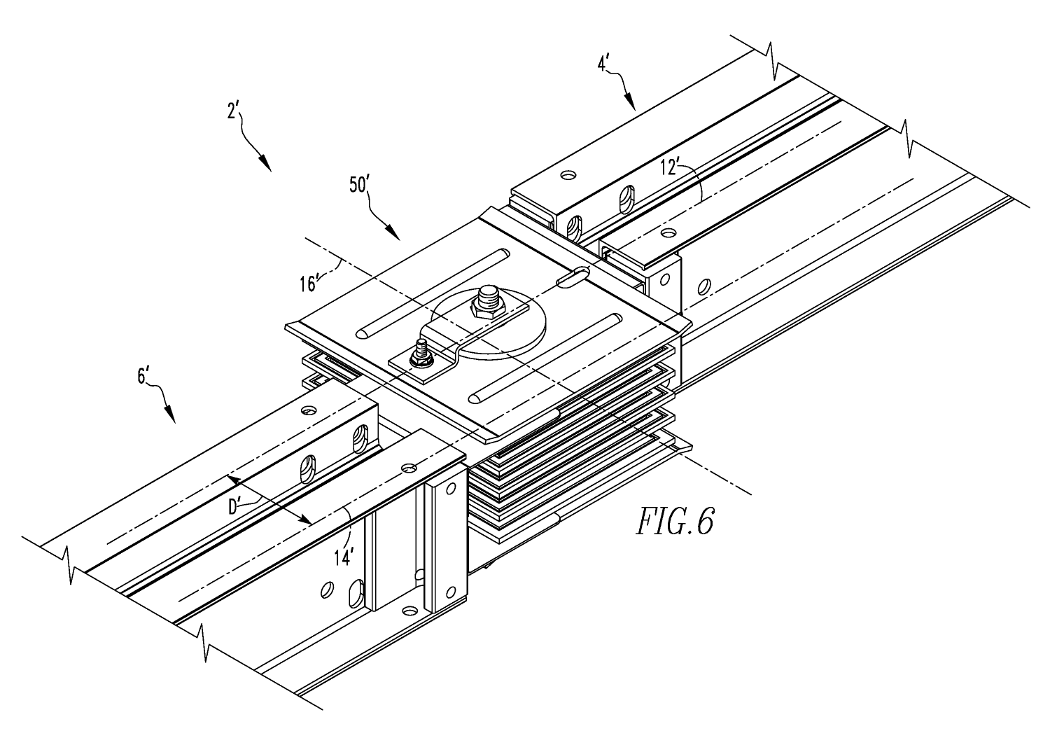

FIG. 6 shows another example of a coupling assembly 50′ for an electrical busway 2′, in accordance with another non-limiting embodiment of the invention. Coupling assembly 50′ provides for a relatively smaller offset distance D′ between the first central axis 12′ and the second central axis 14′ of first and second busway sections 4′,6′ than the offset distance D previously discussed in relation to the example coupling assembly 50 of FIGS. 1-5. As such, it is to be appreciated that the coupling assemblies 50,50′ may readily be varied within the scope of the invention in order to provide specific offsets as required.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A coupling assembly for an electrical busway, said electrical busway including a first section having a first longitudinal axis and a second section having a second longitudinal axis, said coupling assembly comprising:
a plurality of electrical conductors, the plurality of electrical conductors having a first portion and an opposite second portion, the first portion structured to removably electrically and mechanically couple to the first section of said electrical busway, and the second portion structured to removably electrically and mechanically couple to the second section of said electrical busway, said electrical conductors having a third longitudinal axis extending between said first portion and said opposite second portion; and
a plurality of electrical insulators positioned to electrically insulate said plurality of electrical conductors,
wherein said coupling assembly is structured to offset said first longitudinal axis a predetermined non-zero distance from said second longitudinal axis.

2. The coupling assembly of claim 1 wherein the first section of said electrical busway includes a plurality of first bus members; wherein the second section of said electrical busway includes a plurality of second bus members; and wherein each of said plurality of electrical conductors is structured to electrically connect a corresponding one of the first bus members of said first section to a corresponding one of the second bus members of said second section.

3. The coupling assembly of claim 2 wherein each of said plurality of electrical conductors comprises a first plate having a first surface and an opposite second surface and a second plate having a first surface and an opposite second surface; and wherein the opposite second surface of said first plate and the first surface of said second plate are structured to electrically and mechanically engage a corresponding one of the first bus members of said first section and a corresponding one of the second bus members of said second section.

4. The coupling assembly of claim 3 wherein said plurality of electrical conductors and said plurality of electrical insulators are arranged in an alternating stack coupled together by a fastening mechanism.

5. The coupling assembly of claim 4 wherein said alternating stack comprises an arrangement of said plurality of electrical conductors and said plurality of electrical insulators; and wherein each of the plurality of electrical conductors lies between a corresponding pair of said plurality of electrical insulators.

6. The coupling assembly of claim 4 wherein said fastening mechanism comprises a fastening member passing through said alternating stack.

7. The coupling assembly of claim 4 wherein said fastening mechanism comprises a first fastening member passing through said alternating stack proximate said first portion and a second fastening member passing through said alternating stack proximate said opposite second portion.

8. The coupling assembly of claim 1 wherein said third longitudinal axis is normal to both of said first longitudinal axis and said second longitudinal axis.

9. The coupling assembly of claim 1 wherein said electrical conductors have a generally rectangular cross section.

10. An electrical busway comprising:
a first section having a first longitudinal axis;
a second section spaced apart from said first section, said second section having a second longitudinal axis; and
a coupling assembly comprising:
a plurality of electrical conductors, the plurality of electrical conductors having a first portion and an opposite second portion, the first portion removably electrically and mechanically coupling to the first section of said electrical busway, and the second portion removably electrically and mechanically coupling to the second section of said electrical busway, said electrical conductors having a third longitudinal axis extending between said first portion and said opposite second portion; and
a plurality of electrical insulators positioned to electrically insulate said plurality of electrical conductors,
wherein said coupling assembly offsets said first longitudinal axis a predetermined non-zero distance from said second longitudinal axis.

11. The electrical busway of claim 10 wherein the first section of said electrical busway includes a plurality of first bus members; wherein the second section of said electrical busway includes a plurality of second bus members; and wherein each of said plurality of electrical conductors electrically connects a corresponding one of the first bus members of said first section to a corresponding one of the second bus members of said second section.

12. The electrical busway of claim 11 wherein each of said plurality of electrical conductors comprises a first plate having a first surface and an opposite second surface and a second plate having a first surface and an opposite second surface; and wherein the opposite second surface of said first plate and the first surface of said second plate electrically and mechanically engage a corresponding one of the first bus members of said first section and a corresponding one of the second bus members of said second section.

13. The electrical busway of claim 12 wherein said plurality of electrical conductors and said plurality of electrical insulators are arranged in an alternating stack coupled together by a fastening mechanism.

14. The electrical busway of claim 13 wherein said alternating stack comprises an arrangement of said plurality of electrical conductors and said plurality of electrical insulators; and wherein each of the plurality of electrical conductors lies between a corresponding pair of said plurality of electrical insulators.

15. The coupling assembly of claim 13 wherein said fastening mechanism comprises a fastening member passing through said alternating stack.

16. The electrical busway of claim 15 wherein said fastening mechanism comprises a first fastening member passing through said alternating stack proximate said first portion and a second fastening member passing through said alternating stack proximate said second portion.

17. The electrical busway of claim 10 wherein said third longitudinal axis is normal to both of said first longitudinal axis and said second longitudinal axis.

18. The electrical busway of claim 10 wherein said electrical conductors have a generally rectangular cross section.

19. A coupling assembly for an electrical busway, said electrical busway including a first section comprising a first housing having a first longitudinal axis and a second section comprising a second housing having a second longitudinal axis, said coupling assembly comprising:
a plurality of electrical conductors, the plurality of electrical conductors having a first portion and an opposite second portion, the first portion structured to removably electrically and mechanically couple to the first section of said electrical busway, and the second portion structured to removably electrically and mechanically couple to the second section of said electrical busway;
a plurality of electrical insulators positioned to electrically insulate said plurality of electrical conductors; and
a coupler housing comprising a first portion structured to be coupled to said first housing and a second portion structured to be coupled to said second housing,
wherein said coupling assembly is structured to offset said first longitudinal axis a predetermined non-zero distance from said second longitudinal axis.

20. The coupling assembly of claim 19 wherein the first section of said electrical busway includes a plurality of first bus members; wherein the second section of said electrical busway includes a plurality of second bus members; and wherein each of said plurality of electrical conductors is structured to electrically connect a corresponding one of the first bus members of said first section to a corresponding one of the second bus members of said second section.

21. The coupling assembly of claim 20 wherein each of said plurality of electrical conductors comprises a first plate having a first surface and an opposite second surface and a second plate having a first surface and an opposite second surface; and wherein the opposite second surface of said first plate and the first surface of said second plate are structured to electrically and mechanically engage a corresponding one of the first bus members of said first section and a corresponding one of the second bus members of said second section.

22. The coupling assembly of claim 21 wherein each of said plurality of electrical insulators is of generally linear shape; and wherein said plurality of electrical conductors and said plurality of electrical insulators are arranged in an alternating stack coupled together by a fastening mechanism.

23. The coupling assembly of claim 22 wherein said alternating stack comprises an arrangement of said plurality of electrical conductors and said plurality of electrical insulators; and wherein each of the plurality of electrical conductors lies between a corresponding pair of said plurality of electrical insulators.

24. The coupling assembly of claim 22 wherein said fastening mechanism comprises a fastening member passing through said alternating stack.

25. The coupling assembly of claim 22 wherein said fastening mechanism comprises a first fastening member passing through said alternating stack proximate said first portion and a second fastening member passing through said alternating stack proximate said second portion.
